(19) United States
(12) Patent Application Publication
(10) Pub. No.: US 2014/0106888 A1
(43) Pub. Date: Apr. 17, 2014

(54) TURN-BASED EXCHANGES

(71) Applicant: APPLE INC., Cupertino, CA (US)

(72) Inventors: Christina E. Warren, San Jose, CA (US); Nathan D. Taylor, Scotts Valley, CA (US)

(73) Assignee: APPLE INC., Cupertino, CA (US)

(21) Appl. No.: 13/772,248

(22) Filed: Feb. 20, 2013

Related U.S. Application Data
(60) Provisional application No. 61/714,695, filed on Oct. 16, 2012.

(51) Int. Cl. A63F 13/12

(52) U.S. Cl. CPC A63F 13/12
USPC 463/42

(57) ABSTRACT

System of structuring match data updates in multiplayer games includes a plurality of portable electronic devices and a server. Each device may execute a match and store match data. A current device, which is one of the devices, controls the current turn in the match. The current device may establish exchanges that occur during the current turn which includes at least one of: (i) sending a request to at least one of the devices, (ii) receiving a request from at least one of the devices, (iii) receiving a reply to a request from at least one of the devices, and (iv) sending a reply to a request to at least one of the devices. The server is communicatively coupled with the devices to synchronize the match data stored on each of the devices when the current device updates the match data stored on the current device. Other embodiments are described.

### CROSS-REFERENCE TO RELATED APPLICATIONS

This application claims the benefit pursuant to 35 U.S.C. 119(e) of U.S. Provisional Application No. 61/714695, filed Oct. 16, 2012, which application is specifically incorporated herein, in its entirety, by reference.

### FIELD

An embodiment of the invention relate generally to the implementation of turn-based exchanges in multiplayer games on mobile devices and more specifically, a system and method of structuring match data updates in multiplayer games on mobile devices.

### BACKGROUND

Currently, in addition to desktop computers and video game consoles, a wide range of portable consumer electronics may be used to play video games. These portable consumer electronics may include, for example, smart phones, laptops, notebooks, tablet computers, and personal digital media players.

All types of video games are available to be played by users on their portable consumer electronics. These games may be single-player games that can only be played by a single user on their device or multiplayer games where two or more players play the game with each other using their respective devices.

In simple multi-player video games such as the card game “Go Fish”, the turn order of the game is well-defined. For instance, if four players are playing a game of “Go Fish”, each of the players (e.g., first player to the fourth player) would take turns playing one card each in sequence. To address coherency and contention problems, the current model implemented is the “talking stick” model. In this model, each player on his respective device has a view of the match (i.e., the object that describes the current game of “Go Fish”) and each player has a copy of the match data (i.e., the data that is associated with the match). The player whose turn it is in the match has the “talking stick” and thus, has full control over the game state. In other words, only the player having the “talking stick” can make changes to the match data.

However, many multiplayer video games are more complicated in that the flow of the game is not as linear. Examples of such multiplayer video games are adaptations of board games such as Monopoly™ or Risk™. In Monopoly™, the first player may land on Boardwalk, he does not choose to buy the property so the property goes up for auction. In the auction scenario, the “talking stick” model would not be effective since, among other things, the second, third, and fourth players would have to be provided a sequential turn, the users would not be able to bid concurrently, and a delay in response from any of the users would stall the match. Similarly, in Risk™, the “talking stick” model does not allow for a user to trade or create collusion. For instance, when the first user obtains China, the third user cannot offer to help the first user obtain Mongolia in exchange for Australia, since it is not his turn to play (i.e., third user does not have the “talking stick”).

### SUMMARY

In order to provide the user with a better user experience, the manner in which the match data is updated should mirror the natural flow of the multiplayer game. In lieu of the “talking stick” model, one embodiment of the invention implements a structured messaging or update mechanism called exchanges that involve the current player (e.g., the player who has the current turn in the match) to structure the match data updates in the game.

In one embodiment, the system of structuring match data updates in multiplayer games comprises: a plurality of portable electronic devices and a server. Each of the plurality of devices may execute a match and store match data. A current device, which is one of the plurality of devices, controls the current turn in the match and controls the updates to the match data (e.g., the game state). The current device may establish exchanges that occur during the current turn which includes at least one of: (i) sending a request to at least one of the plurality of devices, (ii) receiving a request from at least one of the plurality of devices, (iii) receiving a reply to a request from at least one of the plurality of devices, and (iv) sending a reply to a request to at least one of the plurality of devices. The server is communicatively coupled with the plurality of devices to synchronize the match data stored on each of the plurality of devices when the current device updates the match data stored on the current device.

In another embodiment, method of structuring match data updates in multiplayer games starts with executing a version of an application by each of a plurality of portable electronic devices, respectively. A current device included in the plurality of devices may control a current turn in the match. The current device then establishes exchanges that occur during the current turn in the match which includes at least one of: (i) sending a request to at least one of the plurality of devices, (ii) receiving a request from at least one of the plurality of devices, (iii) receiving a reply to a request from at least one of the plurality of devices, and (iv) sending a reply to a request to at least one of the plurality of devices. The current device may then update the match data stored on the current device during the current turn and the server may synchronize the match data stored on each of the plurality of devices when the current device updates the match data stored on the current device.

In another embodiment, a method of structuring match data updates in multiplayer games starts with each of a plurality of portable electronic devices executing a version of an application. A current device included in the plurality of devices controls a current turn in the match. The current device may then update the match data stored on the current device during the current turn and a server may synchronize the match data stored on each of the plurality of devices when the current device updates the match data stored on the current device. The current device may then send a message to the server indicating an end of the current turn. The message may further include an order of the plurality of devices. The server may then select a first device to be the current device that controls a subsequent turn based on the order included in the message. The first device is included in the plurality of devices. In some embodiments, the message further includes a timeout associated with each of the plurality of devices, respectively. When the timeout is reached, the server selects a second device to be the current device based on the order. The second device is included in the plurality of devices.

The above summary does not include an exhaustive list of all aspects of the present invention. It is contemplated that the invention includes all systems, apparatuses and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 illustrates examples of portable consumer electronic devices used in a network system according to one embodiment of the invention.

FIG. 2 shows a network system according to one embodiment of the invention.

FIG. 3 shows a block diagram of the example server according to one embodiment of the invention.

FIG. 4 shows a sequence diagram of one embodiment of method of structuring match data updates according to one embodiment of the invention.

FIG. 5 shows a sequence diagram of one embodiment of method of structuring match data updates according to one embodiment of the invention.

FIG. 6 shows a sequence diagram of one embodiment of method of structuring match data updates according to one embodiment of the invention.

FIG. 7 illustrates a flow diagram of an example method of structuring match data updates according to one embodiment of the invention.

FIG. 8 illustrates a flow diagram of an example method of structuring match data updates according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

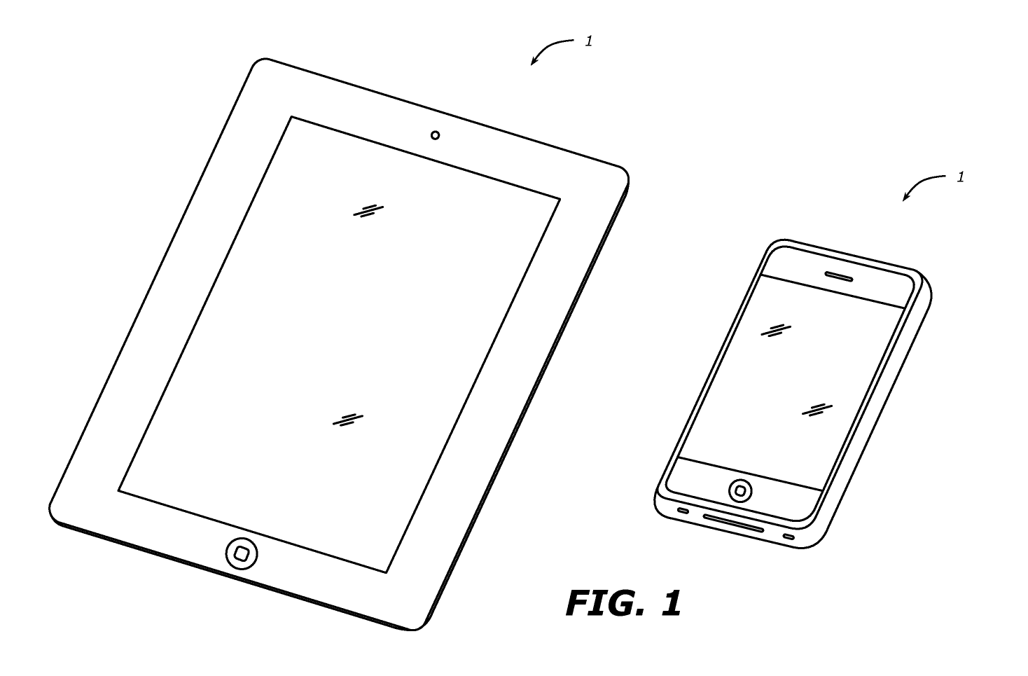

FIG. 1 illustrates examples of a portable consumer electronic device (or “mobile device”) that is used in a network system according to one embodiment of the invention. As shown in FIG. 1, the mobile device 1 may be a mobile telephone communications device or a smartphone such as an iPhone™ device, from Apple Inc. of Cupertino, Calif., or a tablet computer such as an iPad™ device, from Apple Inc. of Cupertino, Calif. The mobile device 1 may also be a personal digital media player such an iPod™ device or a notebook computer such as a MacBook Air™ device, which are all from Apple Inc. of Cupertino, Calif.

A device housing (also referred to as the external housing) encloses a plurality of electronic components of the device 1. For example, the device 1 may include electronic components such as a processor, a data storage containing an operating system and application software for execution by the processor, input-output devices such as a display screen that may be a touch-sensitive screen (“touch screen”), a microphone port, and speaker ports, and a plurality of sensors such as ambient light sensors, an accelerometer, and a proximity sensor. Input-output devices may also include wireless communications devices having communications circuitry such as radio frequency (RF) transceiver circuitry, antennas, etc . . . In one embodiment, the microphone port and the speaker ports may be coupled to the communications circuitry to enable the user to participate in wireless telephone or video calls. A variety of different wireless communications networks and protocols may be supported in the mobile device 1. These include: a cellular mobile phone network (e.g. a Global System for Mobile communications, GSM, network), including current 2G, 3G and 4G networks and their associated call and data protocols; and an IEEE 802.11 data network (WiFi or Wireless Local Area Network, WLAN).

The mobile device 1 may have video games installed therein. When a video game is executed by the processor of the device 1, the graphical user interface (GUI) of the game is displayed to the user. The user may interact with the video game by using the touch-screen of the device 1 or by manipulating the mobile device 1 in a manner that the sensors in the mobile device provide corresponding inputs to the game. While FIG. 1 illustrates examples of mobile device 1, it is understood that embodiments of the invention may also be implemented in a non-mobile device such as a compact desktop computer such as an iMac™, from Apple Inc. of Cupertino, Calif.

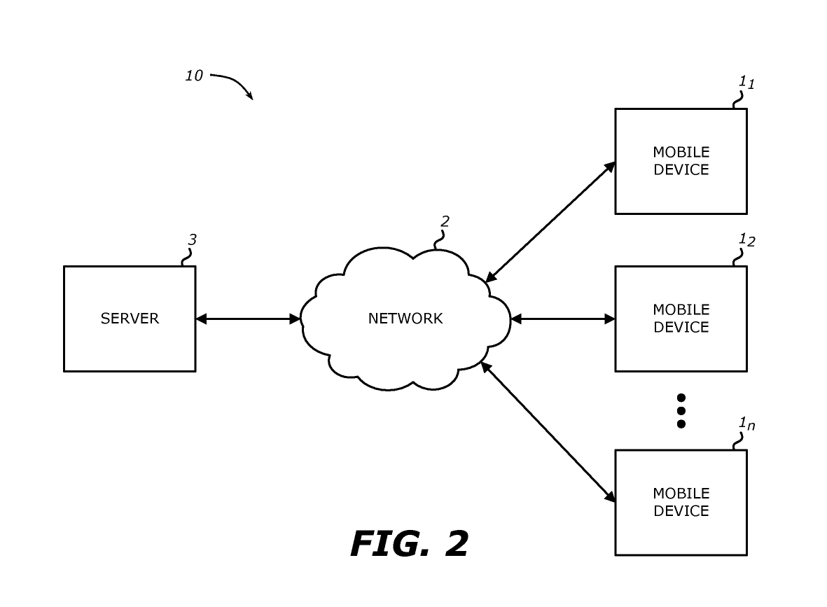

FIG. 2 shows a network system according to one embodiment of the invention. The system 10 may be a networked system that includes a plurality of mobile devices 1₁-1ₙ (n>1) coupled to a server 3 via a trusted and/or un-trusted network 2. The network 2 may be physically located in a secure location to be trusted or may be trusted according to secure connections based on cryptographic protocols, e.g., SSL (Secure Socket Layer), PVN (Private Virtual Networking), or other connections. The network 2 may be a cellular mobile phone network (e.g. a Global System for Mobile communications, GSM, network), including current 2G, 3G and 4G networks and their associated call and data protocols; and an IEEE 802.11 data network (WiFi or Wireless Local Area Network, WLAN).

In one embodiment, a first user using a mobile device 1₁, a second user using mobile device 1₂, a third user using the mobile device 1₃, and a fourth user using the mobile device 1₄ are playing a multiplayer video game on their respective devices. The four users are playing a match of the multiplayer video game in this embodiment. Each of the mobile devices includes a processor that may be executing a version of an application and a storage to that may store a copy of the match data. One of the mobile devices, for instance mobile device 1₁, may be the device that is controlling the current turn in the match called the “current device.” For example, it may be the first user's turn to roll the dice in a game of Monopoly™. In this example, the first user may roll the dice and land on the Boardwalk property. If the first user decides to purchase Boardwalk, the match data in the mobile device 1₁ is updated and the mobile device 1₁ may send a message to the server 3 via network 2 that indicates the end of the first user's turn. In some embodiments, the message may also indicate the changes made by the current device to the match data. Using this information, the server 3 may synchronize the match data stored on each of the other mobile devices 1₂, 1₃, and 1₄ to reflect the changes made on by the current device. Accordingly, in one embodiment, the server 3 may synchronize the match data by sending a message to each of the mobile devices 1₂, 1₃, and 1₄ that includes the match data changes when the current device updates the match data stored on the current device.

In this embodiment, the mobile device 1₁, as the current device, may also establish exchanges that occur during the current turn in the match. For example, having landed on Boardwalk, the first user may decide that he does not want to buy Boardwalk but rather put Boardwalk up for auction to the other users. The mobile device 1₁ as the current device may establish exchanges that occur during this current turn in the match. In this example, the mobile device 1₁ may establish exchanges by sending a request for bids to at least one of the mobile devices 1₂, 1₃, 1₄ and also receive a bid as a reply from at least one of the mobile devices 1₂, 1₃, 1₄. In another example, when the first user lands on Boardwalk, the mobile device 1₁ may also establish exchanges by receiving a request from at least one of the mobile devices 1₂, 1₃, 1₄ to sell Boardwalk and also send a reply to the request to at least one of the mobile devices 1₂, 1₃, 1₄. In each of the examples, the exchanges that are established by the current device may be required to involve the current device.

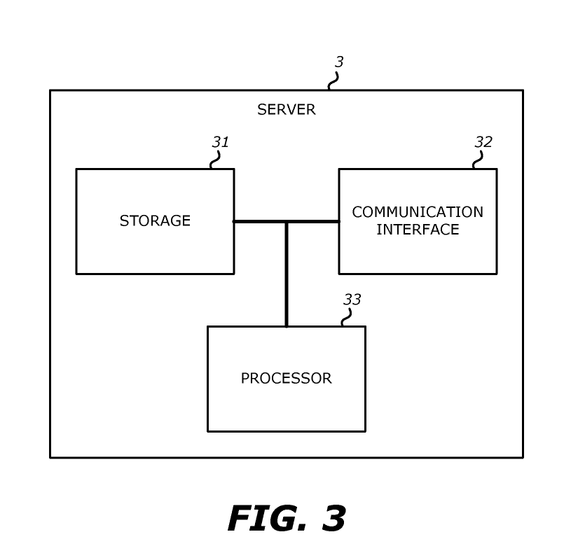

Referring to FIG. 3, the server 3 according to one embodiment of the invention is further illustrated. The server 3 may include a storage 31, a communication interface 32, and a processor 33.

The communication interface 32 may be an interface that is coupled to the network 2 in order to receive for example messages from the first device 1₁ that indicate the end of a current turn and transmit a message to the second device 1₂ that indicates that the second device 1₂ is now the current device in this subsequent turn. The message may also indicate changes made by the current device to the match data such that the communication interface 32 may be used to synchronize the match data stored on each of the other mobile devices 1₂, 1₃, and 1₄ by sending a message to each of the mobile devices 1₂, 1₃, and 1₄ that includes the match data changes. The current device may also establish the exchanges via the communication interface 32 using SMS messages, or within the match using WiFi, 3G, or 4G networks.

As shown in FIG. 3, the storage 31 is coupled to the communication interface 32 and stores, for example, the match and the match data which is updated based on the messages received by the communication interface 32. For instance, in some embodiments, at the end of the current turn, the updated match data may be included in a message received by the communication interface 32 which establishes which mobile device is next to be the current device. Further, in one embodiment, at the end of the current turn, the current device may send a message to the server 3 which includes a vector with an order of the devices and timeouts associated with each of the devices. This vector may also be stored in the storage 31. The storage 31 may include one or more different types of storage such as hard disk drive storage, nonvolatile memory, and volatile memory such as dynamic random access memory.

Referring to FIG. 3, the processor 33 may be coupled to the communication interface 32 and the storage 31. The processor 33 may be a microprocessor, a microcontroller, a digital signal processor, or a central processing unit. The term “processor” may refer to a device having two or more processing units or elements, e.g. a CPU with multiple processing cores. The processor 33 may be used to control the operations of server 3 by executing software instructions or code stored in the storage 31.

In some embodiments, the processor 33 may determine that the match data was updated by the current device based on the message received from the current device (e.g., mobile device 1₁) and may update the match and match data stored in the storage 31 accordingly. The processor 33 may also cause the communication interface 32 to transmit a request or a reply to at least one of the mobile devices 1₂, 1₃, and 1₄ and receive a request from at least one of the mobile devices 1₂, 1₃, and 1₄. When the processor 33 transmits a request or replay to at least one of the mobile devices (e.g., mobile device 1₂), the processor 33 may signal to the communication interface 32 to transmit a notification to the mobile device 1₂. The notification may be displayed on the display screen of the mobile device 1₂ for the second user. In one embodiment, the notification is displayed as banner or a badge. The notification may also be displayed on the display screen when the user activates the match or the multiplayer game.

The following embodiments of the invention may be described as a process, which is usually depicted as a flowchart, a flow diagram, a sequence diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

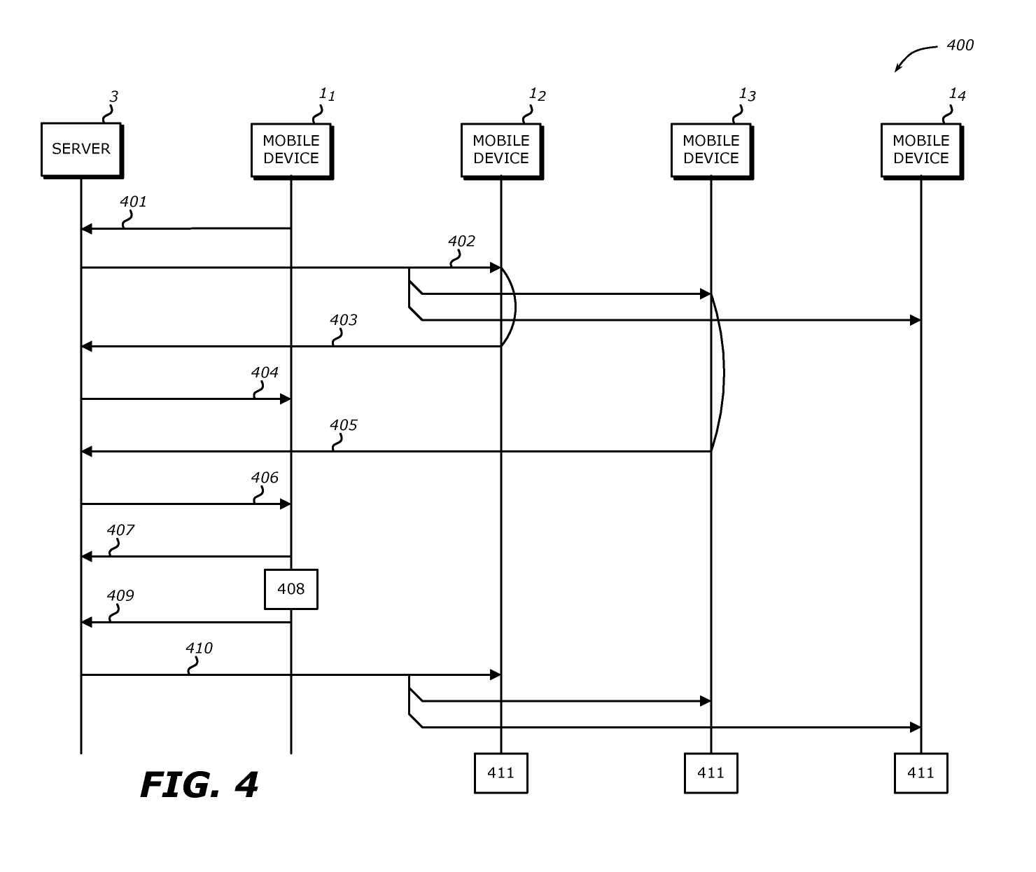

FIG. 4 shows a sequence diagram of one embodiment of method of structuring match data updates according to one embodiment of the invention. In the sequence diagram 400, there are four mobile devices 1₁, 1₂, 1₃, and 1₄ that are communicatively coupled to a server 3. Using the mobile devices, players on their respective devices are playing a multiplayer game with one another. In FIG. 4, the players may be playing, for instance, a game of Monopoly™ and the first user on mobile device 1₁ has control of the current turn such that mobile device 1₁ is the current device. For example, having landed on Boardwalk, the first user decides that he does not want to buy Boardwalk but rather put Boardwalk up for auction to the other users. The mobile device 1₁ as the current device may establish exchanges that occur during this current turn in the match. Accordingly, at Sequence 401, the current device sends a message to the server 3 that includes a request to each of the mobile devices 1₂, 1₃, 1₄. In this example, the mobile device 1 ₁ may be sending a request for bids for the purchase of Broadway. The request to each of mobile devices 1₂, 1₃, 1₄ may be a separate request to each device 1₂, 1₃, 1₄. At Sequence 402, the server 3 sends the request to each of the mobile devices 1₂, 1₃, 1₄. At Sequence 403, the mobile device 1₂ may send a reply to the request received to the server 3 which relays the reply from mobile device 1₂ to the current device (e.g., mobile device 1₁) at Sequence 404. The reply may include an amount that the second user wishes to bid for the purchase of Broadway. At Sequence 405, the mobile device 1₃ may also transmit a reply to the request received to the server 3 which relays the reply to the current device at Sequence 405. At Sequence 407, the current device may decide to cancel the exchange with mobile device 1₄ because the mobile device 1₄ does not provide a reply to the request within a specified period of time. This specified period of time may be referred to as a timeout and may be included in the request sent to each mobile device in Sequence 402. Alternatively to the Sequence 407, the current device may also cancel the exchanges with mobile device 1₃ and 1₄ because it chooses to complete a transaction with mobile device 1₂. For example, instead of mobile device 1₄ timing out, the mobile device 1₁ may be satisfied with the bid received from mobile device 1₂ such that the current device does not want to accept the bid from mobile device 1₃ and does not wish to wait for a reply from 1₄. In other embodiments, all pending exchanges are cancelled when the current player (i.e., first player on mobile device 1₁) ends the current turn. A notification may be sent to indicate that exchange has been cancelled. Accordingly, at Sequence 408, the current device updates the match data stored therein to reflect the exchange between the current device and, for example, the mobile device 1₂. At Sequence 409, the current device may send a message to server 3 that indicates the end of the current turn by the first player. In some embodiments, the message in Sequence 409 may also include the changes to the match data as updated by the mobile device 1₁₁. At Sequence 410, the server 3 may determine that an update to the match data has occurred based on the message received at Sequence 409 and sends an update message to each of the mobile devices 1₂, 1₃, 1₄ that may include the updates to the match data as updated by the mobile device 1₁ during the first player's turn. At Sequence 411, each of these mobile devices 1₂, 1₃, 1₄ may update their respectively stored match data to reflect the changes made by mobile device 1₁ during the first user's turn.

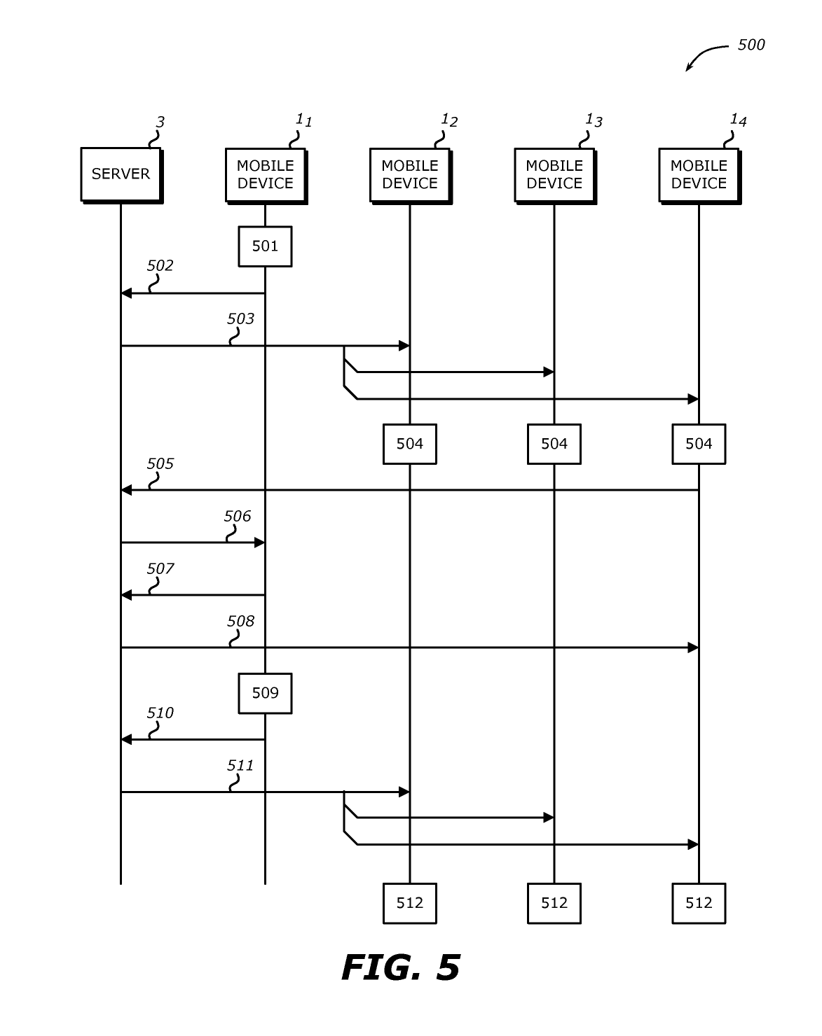

FIG. 5 shows a sequence diagram of one embodiment of method of structuring match data updates according to one embodiment of the invention. In Sequence 500, when the first user lands on Boardwalk, the mobile device 1₁ (e.g., the current device) may update its stored match data to reflect that the first user landed on Boardwalk (Sequence 501). At Sequence 502, the mobile device 1₁ may send a message to server 3 that includes the change in the match data stored by the mobile device 1₁ (e.g., the first user has landed on Boardwalk). At Sequence 503, the server 3 may send an update message to each of the mobile devices 1₂, 1₃, 1₄ that may include the updates to the match data as updated by the mobile device 1₁. At Sequence 504, each of these mobile devices 1₂, 1₃, 1₄ may update their respectively stored match data to reflect the changes made by mobile device 1₁ during the first user's turn. While the first player is deciding whether to purchase Boardwalk, the mobile device 1₁ (e.g., the current device) may also establish exchanges by receiving a request from at least one of the mobile devices 1₂, 1₃, 1₄. For instance, the fourth user may own Park Place and wish to purchase Boardwalk from the first user. In Sequence 505, while it is not the fourth user's turn in the match, the fourth user via the mobile device 1₄ may send a request to the current device (e.g., mobile device 1₁) via server 3. The request may include a request to sell Boardwalk for a given bid price. At Sequence 506, the server 3 receives and relays the request from mobile device 1₄ to the current device being mobile device 1₁. At Sequence 507, the current device sends a reply to the request from mobile device 1₄ to server 3. For instance, the current device may be inclined to accept to sell Boardwalk to the fourth user for the given bid price. Accordingly, the response being sent to the server 3 includes an acceptance of the request sent in Sequence 505. At Sequence 508, the server 3 relays the reply from the current device to the fourth user at mobile device 1₄. Accordingly, at Sequence 509, the current device updates the match data stored therein to reflect the exchange between the current device and, for example, the mobile device 1₄. At Sequence 510, the current device may send a message to server 3 that indicates the end of the current turn by the first player. In some embodiments, the message in Sequence 510 may also include the changes to the match data as updated by the mobile device 1₁. At Sequence 511, the server 3 may determine that an update to the match data has occurred based on the message received at Sequence 510 and sends an update message to each of the mobile devices 1₂, 1₃, 1₄ that may include the updates to the match data as updated by the mobile device 1₁ during the first player's turn. At Sequence 512, each of these mobile devices 1₂, 1₃, 1₄ may update their respectively stored match data to reflect the changes made by mobile device 1₁ during the first user's turn.

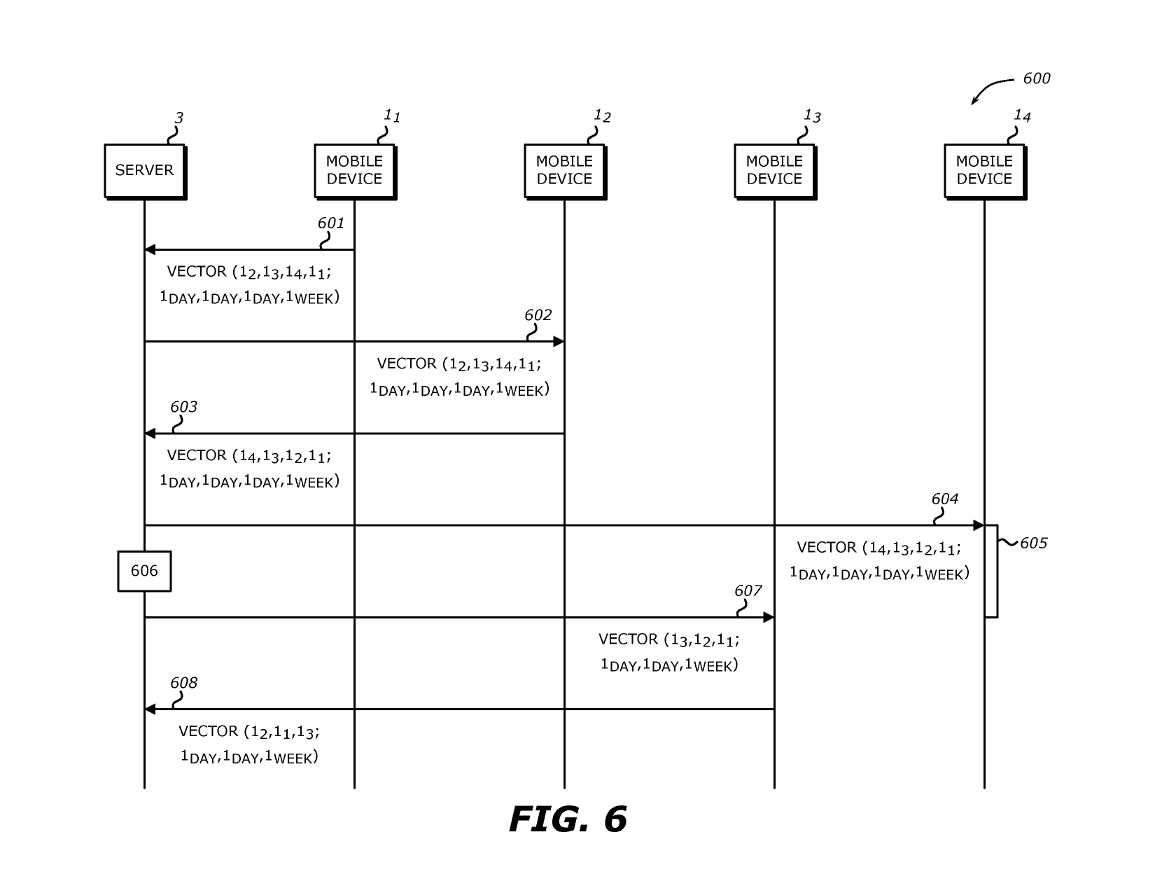

In order to further structure the match data updates by the mobile devices 1₁-1₄, the message that is sent from the current device to the server 3 to indicate the end of the current turn may also include a vector that provides an order of the mobile devices 1₁-1₄. This order delineates the order in which the turns in the match are to proceed. For instance, after the first user on mobile device 1₁ completes his turn, it may be the second user, the third user, and then the fourth user's turn in sequence. Accordingly, the vector would include an order of the mobile devices being: (mobile devices 1₂, 1₃, 1₄, and 1₁). This order may be determined by the user on current device or automatically based on the match data. In another embodiment, the vector that provides an order of the mobile devices 1₁-1₄ may also include a timeout which is a maximum amount of time that a user has to make play his turn. In some embodiments, the vector may include a timeout for each of the mobile devices 1₁-1₄. The timeouts in this embodiment may the same timeout or a different timeout. The values of the timeouts may also be determined by the user on current device or automatically based on the match data. FIG. 6 shows a sequence diagram of one embodiment of method of structuring match data updates according to this embodiment of the invention. Sequence 600 starts with mobile device 1₁ completing the current turn and sending a message including a vector including the order and timeouts associated to each mobile device, respectively (Sequence 601). In Sequence 601, the vector includes an order being (Mobile devices 1₂, 1₃, 1₄, and 1₁) and timeouts being (1 day, 1 day, 1 day, and 1 week), for example. As shown in the vector, the timeout that the first user assigns to himself may be longer than the other timeouts in order to provide himself with extra time to respond. At Sequence 602, based on a reading of the order included in the vector, the server 3 may select mobile device 1₂ as the current device for the subsequent turn and relays the message to the mobile device 1₂ that includes the vector as received from mobile device 1₁ in Sequence 601. At Sequence 603, the second user on the mobile device 1₂ completes his turn and sends a message to the server 3 to indicate that the current turn has ended. As in Sequence 601, this message from mobile device 1₂ may also include an order and timeouts associated with each of the mobile devices. For example, in Sequence 603, the message includes an order being (Mobile devices 1₄, 1₃, 1₂, and 1₁) and timeouts being (1 day, 1 day, 1 day, and 1 week). At Sequence 604, the server 3 reads the order included in the message to determine that the mobile device 1₄ is the next current device and relays the message from Sequence 603 to the mobile device 1₄. In some embodiments, the server 3 may also store the message in storage 31.

At Sequence 605, the fourth user on mobile device 1₄ may not have time to play his turn within the time period set forth by the timeout associated with mobile device 1₄ (e.g., 1 day). Rather than stalling the match for the rest of the users, this embodiment of the invention allows for the match to continue in an orderly manner. For instance, once the fourth user times out for not playing his turn within a day of receiving the message from the server 3 in Sequence 604, the server 3 may determine at Sequence 606 that the fourth user on mobile device 1₄ forfeits the match or that the fourth user on mobile device 1₄ loses his turn. At Sequence 607, the server 3 refers to the message stored in storage 31 to determine that mobile device 1₃ is the next device to be current device after the mobile device 1₄ according to the order in the message. Having identified the next current device, the server 3 may then send a message to mobile device 1₃ that indicates to the mobile device 1₃ that it is new current device. In this example, at Sequence 606, the server 3 determined that the mobile device 1₄ forfeits the match such that at Sequence 607, the message includes a new order being (Mobile devices 1₃, 1₂, and 1₁) and timeouts being (1 day, 1 day, and 1 week). In some embodiments, the server 3 may also store this message in storage 31 to update its content to reflect the new order and timeouts. At Sequence 608, when the third user completes his turn, a message is sent from the mobile device 1₃ to the server 3 that indicates that the current turn has ended and the message further includes a new order being (Mobile devices 1₂, 1₁, and 1₃) and timeouts being (1 day, 1 day, and 1 week).

In some embodiments, when a timeout is determined to have occurred (e.g., Sequence 606), the server 3 may also cause the turn to fallback to the previous current player. Moreover, when a timeout is determined to have occurred, all existing exchanges may be canceled and the various mobile devices involved in the cancelled exchanges are notified by the server.

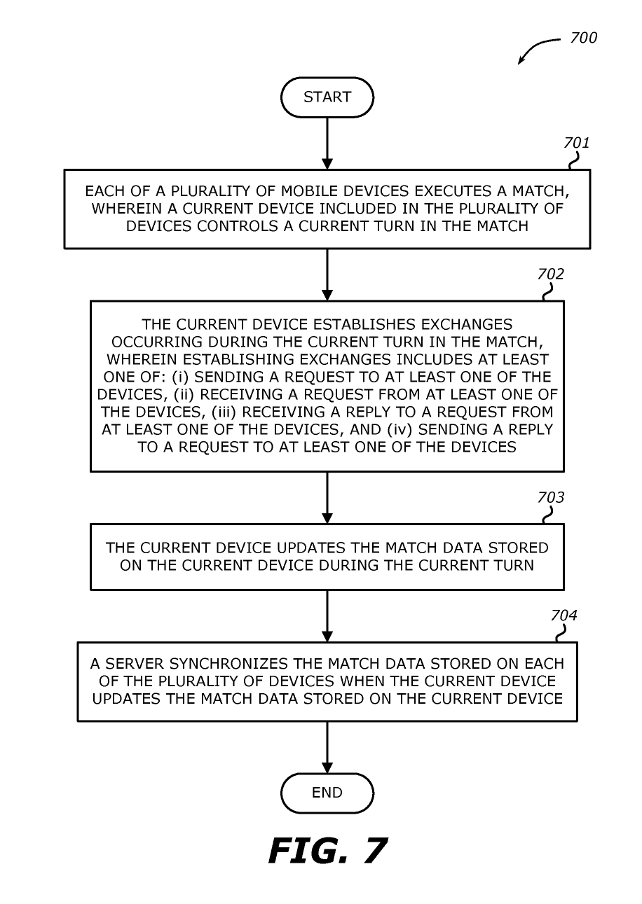

FIG. 7 illustrates a flow diagram of an example method of structuring match data updates according to one embodiment of the invention. Method 700 starts with each of a plurality of mobile devices executing a version of an application of a multiplayer game. One of the devices is a current device that controls a current turn in the match (Block 701). At Block 702, the current device establishes exchanges that occur during the current turn in the match. Establishing exchanges may include at least one of: (i) sending a request to at least one of the devices, (ii) receiving a request from at least one of the devices, (iii) receiving a reply to a request from at least one of the devices, and (iv) sending a reply to a request to at least one of the devices. At Block 703, the current device may update the match data stored on the current device during the current turn and at Block 704, a server may synchronize the match data stored on each of the devices when the current device updates the match data stored on the current device. In another embodiment, at Block 702, devices other than the current device may establish an exchange (e.g., “side exchange”) during the current device's current turn in the match. In this embodiment, at Block 703, the current device receives a notification from the device that established the side exchange that a side exchange is completed. Upon receipt of the notification and prior to the current device ending the current turn, the current device may update the match data stored the current device to reflect a match data that merges the changes to the match data that occurred in the exchange as well as the side exchange.

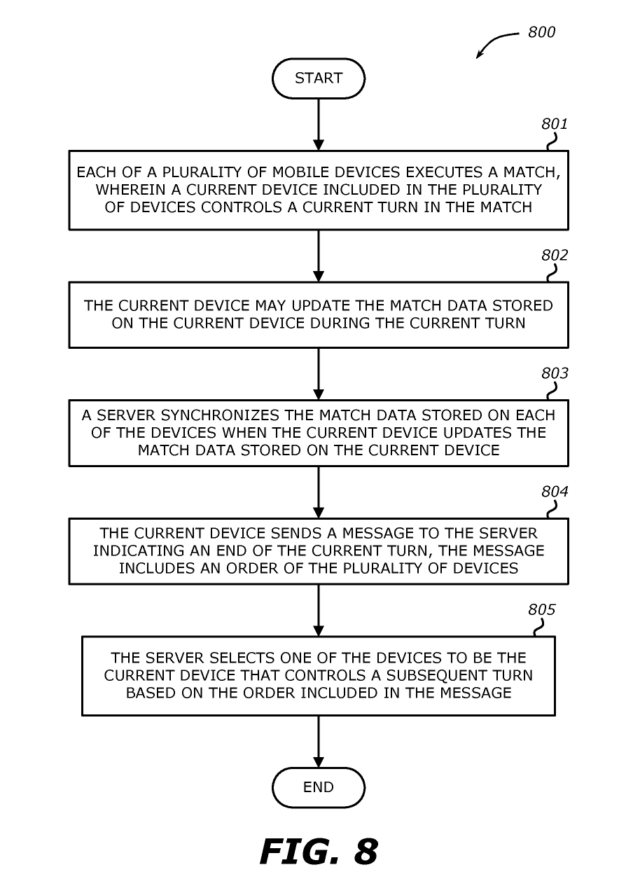

FIG. 8 illustrates a flow diagram of an example method of structuring match data updates according to one embodiment of the invention. The method 800 starts with each of a plurality of mobile devices executing a version of an application of a multiplayer game. One of the devices is a current device that controls a current turn in the match (Block 801). At Block 802, the current device updates the match data stored on the current device during the current turn. At Block 803, a server may synchronize the match data stored on each of the devices when the current device updates the match data stored on the current device. At Block 804, the current device may send a message to the server indicating an end of the current turn. The message may also include an order of the plurality of devices. At Block 805, the server may select one of the devices to be the current device that controls a subsequent turn based on the order included in the message.

While some embodiments of the invention have been described to include a server to receive messages from mobile devices and send messages to mobile devices, it is further contemplated that one embodiment of the invention may be a fully distributed system using peer-to-peer networking. Accordingly, in the peer-to-peer networking embodiments of the FIGS. 4-6, the server is not required and the mobile devices may provide messages directly to one another to update the match data, to indicate the end of a turn, to select a new current device, etc.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

1. A system comprising:
a plurality of portable electronic devices, each of the plurality of devices executing a version of an application and storing match data, wherein a current device establishes exchanges that occur during a current turn in the match, the current device being one of the plurality of devices controlling the current turn, wherein the current device establishing the exchanges includes at least one of: (i) sending a request to at least one of the plurality of devices, (ii) receiving a request from at least one of the plurality of devices, (iii) receiving a reply to a request from at least one of the plurality of devices, and (iv) sending a reply to a request to at least one of the plurality of devices; and
a server communicatively coupled with the plurality of devices to synchronize the match data stored on each of the plurality of devices when the current device updates the match data stored on the current device.

2. The system of claim 1, wherein the current device establishing the exchanges includes at least one of: (i) sending a request to at least one of the plurality of devices via the server, (ii) receiving a request from at least one of the plurality of devices via the server, (iii) receiving a reply to a request from at least one of the plurality of devices via the server, and (iv) sending a reply to a request to at least one of the plurality of devices via the server.

3. The system of claim 1, wherein at the end of the current turn, the updated match data establishes which device of the plurality of devices is the current device during a subsequent turn.

4. The system of claim 1, wherein the exchanges include a timeout.

5. The system of claim 1, wherein, when the timeout occurs, the current device cancels the exchange during the current turn.

6. The system of claim 1, wherein the exchanges are established via a server using SMS messages, or within the match via the server using WiFi, 3G, or 4G networks.

7. The system of claim 1, wherein the current device sends a message to the server indicating an end of the current turn, the message includes an order of the plurality of devices, and wherein the server selects a first device to be the current device that controls a subsequent turn based on the order, the first device being included in the plurality of devices.

8. The system of claim 7, wherein the message includes a timeout associated with the first device, wherein, when the timeout is reached, the server selects a second device to be the current device based on the order, the second device being included in the plurality of devices.

9. The system of claim 7, wherein the message includes a timeout associated with each of the plurality of devices, respectively.

10. The system of claim 1, a plurality of portable electronic devices includes mobile telephone communications devices.

11. A method of structuring match data updates in multiplayer games comprising:
executing a version of an application by each of a plurality of portable electronic devices, respectively, wherein a current device included in the plurality of devices controls a current turn in the match;
establishing exchanges that occur during the current turn in the match by the current device, wherein establishing exchanges includes at least one of: (i) sending a request to at least one of the plurality of devices, (ii) receiving a request from at least one of the plurality of devices, (iii) receiving a reply to a request from at least one of the plurality of devices, and (iv) sending a reply to a request to at least one of the plurality of devices;
updating by the current device the match data stored on the current device during the current turn; and
synchronizing the match data stored on each of the plurality of devices by a server when the current device updates the match data stored on the current device.

12. The method of claim 11, wherein at the end of the current turn, the updated match data establishes which device of the plurality of devices is the current device during a subsequent turn.

13. The method of claim 11, wherein the exchanges include a timeout.

14. The method of claim 11, further comprising:
cancelling the exchange during the current turn by the current device when the timeout occurs.

15. The method of claim 11, wherein the exchanges are established via a server using SMS messages, or within the match via the server using WiFi, 3G, or 4G networks.

16. The method of claim 11, further comprising:
sending by the current device a message to the server indicating an end of the current turn, the message includes an order of the plurality of devices, and selecting by the server a first device to be the current device that controls a subsequent turn based on the order, the first device being included in the plurality of devices.

17. The method of claim 16, wherein the message includes a timeout associated with the first device.

18. The method of claim 17, further comprising:
when the timeout is reached, selecting by the server a second device to be the current device based on the order, the second device being included in the plurality of devices.

19. The method of claim 17, wherein the message includes a timeout associated with each of the plurality of devices, respectively.

20. A method of structuring match data updates in multiplayer games comprising:
executing a version of an application by each of a plurality of portable electronic devices, wherein a current device included in the plurality of devices controls a current turn in the match;
updating by the current device the match data stored on the current device during the current turn;
synchronizing the match data stored on each of the plurality of devices by a server when the current device updates the match data stored on the current device;
sending by the current device a message to the server indicating an end of the current turn, the message includes an order of the plurality of devices; and
selecting by the server a first device to be the current device that controls a subsequent turn based on the order, the first device being included in the plurality of devices.

21. The method of claim 20, wherein the message further includes a timeout associated with each of the plurality of devices, respectively.

22. The method of claim 21, further comprising:
when the timeout is reached, selecting by the server a second device to be the current device based on the order, the second device being included in the plurality of devices.

23. A method of structuring match data updates in multiplayer games comprising:
executing a version of an application by each of a plurality of portable electronic devices, respectively, wherein a current device included in the plurality of devices controls a current turn in the match;
establishing exchanges that occur during the current turn in the match by the current device, wherein establishing exchanges includes at least one of: (i) sending a request to at least one of the plurality of devices, (ii) receiving a request from at least one of the plurality of devices, (iii) receiving a reply to a request from at least one of the plurality of devices, and (iv) sending a reply to a request to at least one of the plurality of devices;
updating by the current device the match data stored on the current device during the current turn; and
synchronizing the match data stored on each of the plurality of devices when the current device updates the match data stored on the current device.

24. The method of claim 23, wherein synchronizing the match data stored on each of the plurality of devices includes: transmitting a message from a current device to each of the plurality of devices including the updates to the match data stored on the current device.

25. The method of claim 24, further comprising:
establishing exchanges that occur during the current turn in the match by a other device, the other device being different from the current device;
transmitting a notification from the other device to the current device when the exchange established by the other device is completed; and
upon receipt of the notification and during the current turn, updating by the current device the match data stored the current device to reflect a match data that merges changes to the match data that occurred in the exchanges established by the current device and the exchanges established by the other device.
